(19) United States
(12) Patent Application Publication
(10) Pub. No.: US 2006/0164994 A1
(43) Pub. Date: Jul. 27, 2006

(54) Method and system for transmitting data packets

(76) Inventors: Mark Beckmann, Braunschweig (DE); Michael Eckert, Braunschweig (DE); Martin Hans, Hildesheim (DE)

Correspondence Address: BELL, BOYD & LLOYD, LLC, P. O. BOX 1135, CHICAGO, IL, 60690-1135, US

(21) Appl. No.: 10/516,775

(22) PCT Filed: Jun. 2, 2003
(86) PCT No.: PCT/DE03/01820

§ 371 Date: Dec. 3, 2004

(30) Foreign Application Priority Data
Jun. 5, 2002 (DE) 102 24 994.6

(51) Int. Cl. H04L 1/18; H04J 3/22; H04L 1/00; H04L 12/26; H04J 3/16

(52) U.S. Cl. 370/236; 714/749; 370/465

(57) ABSTRACT

A method is provided for transmitting data packets, which includes sending a data packet from a sender (S) to a recipient (E), and; sending a confirmation message from recipient (E) to sender (S) in order to confirm the receipt of the data packet. When sending the data packet, a timer for monitoring the receipt of the confirmation message is started. According to the present invention, no charges for the transmission of the data packet are assessed when no confirmation message from the recipient (E) arrives within a time frame initiated by the timer.

### BACKGROUND OF THE INVENTION

Methods and systems for transmitting data packets are used, for example, in mobile radio networks.

With many services and applications provided in modern mobile radio networks, messages have to be transmitted not to just one but to two or more mobile radio users. Examples of such services and applications are news groups, video conferences, video on demand and distributed applications.

When transmitting messages to the various users it is possible to send each recipient a copy of the data separately. Such a method can be implemented, but is unsuitable, for large groups. As the same message is transmitted via N (N=number of recipients of the message) individual connections (unicast connections) and is thereby sent a number of times via common connection paths, this method requires a very high bandwidth.

So-called multicast transmission is a better option. Here the various users, to whom the same message is to be transmitted, are combined in a group (multicast group) and only one address (multicast address) is assigned to such group. The data to be transmitted is then sent only once to this multicast address. The multicast messages are ideally sent only once via common connection paths from the sender to the recipients. The sender does not have to know where and how many recipients are concealed behind the multicast address. In order to receive the messages of a specific multicast group, a user must register with the multicast group.

During transmission, messages are sent to a group of users within a regional area. The area in which the message is transmitted is referred to as the broadcast area. The size of the broadcast area is determined by the network operator. Ideally, the message is thereby sent only once as with multicast via common connection paths. It is, however, a disadvantage here that all users within the broadcast area are able to read broadcast messages. In order to read only specific messages and reject or filter others, users can make corresponding adjustments at their terminals. Specific registration for a broadcast service is not necessary.

Users only want to pay for a service if they have actually received the messages of such service. If certain data does not arrive at the mobile radio terminal due to transmission problems, the user cannot be billed for this. A message service such as multicast or broadcast therefore must be sufficiently reliable. Such a reliability requirement can, for example, be guaranteed in that users who have not received certain data send corresponding non-receipt information back to the network and then the “lost” data of the message is transmitted to such users again. One problem here is that such a multi-transmission, in order to guarantee the receipt of data, requires a high outlay, in particular as this data is sent to an entire group of users again; in other words, even to users who have already received the data correctly. The advantage achieved with multicast or broadcast with regard to transmission capacity savings is lost as a result. Also with known systems it is not possible to charge for a service such as broadcast or multicast, as the data is sent unconfirmed from the sender to the recipient. As far as future chargeable services are concerned, however, users only want to pay for data that they have actually received.

The present invention is, therefore, directed toward a method and system for transmitting data packets with which reliable charging is ensured with little network loading.

### SUMMARY OF THE INVENTION

The inventive method for transmitting data packets has the following method stages: a data packet is sent from a sender to a recipient and a confirmation message confirming receipt of the data packet is sent from the recipient to the sender. When sending the data packet, a timer for monitoring receipt of the confirmation message is started.

The present invention is preferably used in a third generation mobile radio network; e.g., UMTS (Universal Mobile Telecommunications System). In such a system, the sender is, for example, a UMTS base station connected to a network and the recipient is a UMTS mobile radio terminal. The present invention can, however, be used for any type of transmission system. The data packets and confirmation message can, in principle, be sent on the basis of any mobile radio standard. The timer determines the time period between the time when the data packet is sent and acknowledgment via a confirmation message returns to the sender within a predefined time interval.

In one embodiment of the present invention, no more data packets are sent from the sender to the recipient if no confirmation message reaches the sender within a time frame started by the timer. In such a case, it can be assumed that the data packets either have not reached the recipient or the recipient is, in principle, not sending confirmation messages back to the sender.

In a development of the present invention, data packets are not charged for if no confirmation message reaches the sender within a time frame started by the timer. Users of the recipient, receiving data packets from the sender, only want to pay a charge for the receipt of data packets, if the data packet has not only been sent by the sender but they have also actually received it. It is possible for a sender to have sent a data packet but for this not to have reached the recipient, for example, due to radio holes. In such a case, it is obvious that the user of the recipient will not want to pay charges for the unused data packet. Therefore, charging does not take place.

In a further development of the present invention, a status request is sent from the sender to the recipient if no confirmation message reaches the sender within a time frame started by the timer. Such a status request can be used to verify the status of the recipient. If, for example, the recipient is no longer able to send confirmation messages to the sender, this can be determined by means of the status request. It is also possible for the user terminal to have been manipulated so that it no longer sends confirmation messages. No proof is therefore provided of the fact that the data packet has actually reached the terminal. In such a case, it can be verified via the status request whether any manipulation is taking place.

According to the present invention, on receipt of a confirmation message the sender resets the timer and the data packet is charged for. This is the normal scenario. On receipt of the confirmation message the timer is reset and started again when a new data packet is sent. As there is proof that the recipient has received the data packet correctly, the data packet can then be charged for.

In yet another development of the present invention, if a data packet is not correctly received and/or is not received, a non-receipt message is sent from the recipient to the sender. If a data packet is not received correctly, that is, if a data packet was not received in full or only partially by the recipient, it is possible for a non-receipt message to be sent to the sender. In such a case charging does not take place. It is also possible, however, for the data packet that was not transmitted correctly to be sent again. It is however also possible, if no data packet was received by the recipient, for a non-receipt message to be sent similarly from the recipient to the sender. In this case, too, charging does not take place or the data packet not received is sent again.

According to the present invention, the number of non-receipt messages received is stored in the storage unit. The number of non-receipt messages received is a measure of the data packets not transmitted correctly. Should too many data packets not be transmitted correctly, it must be verified on the part of the sender whether there is a fundamental problem or whether manipulation is taking place at the recipient. To this end, if a limit value for non-receipt messages received is exceeded, a status request is sent from the sender to the recipient. This status request can, in turn, be used to verify whether a number of non-receipt messages higher than the predefined limit value has been sent to the sender.

The above-mentioned method is also achieved via a system for transmitting data packets with parts for sending a data packet from a sender to a recipient and parts for sending a confirmation message confirming receipt of the data packet from the recipient to the sender, with a timer for monitoring receipt of the confirmation message being started when the data packet is sent.

The present invention also relates to a terminal for use in the inventive method and a terminal for use in the inventive system. The terminal is preferably a mobile radio terminal.

According to the present invention, the recipient sends receipt confirmation to the network on receipt of data packets. In this way, the sender is informed of the correct receipt of the data by the recipient. The recipient is then charged accordingly. The receipt confirmation is preferably also sent back to the network on receipt of a set of data packets that belong together, as it may not be possible to decrypt an incomplete data set and it therefore has no value for the user.

Advantages result with the present invention in that it is still possible to transmit useful data efficiently using resources and channels common to all the recipients. Regardless of this, the confirmation information can be transmitted back to the sender either via recipient-specific or common channels. The use of recipient-specific channels is thereby particularly advantageous as it is possible to use only one bit for the confirmation information (1=received, 0=not received).

On receipt of a receipt confirmation, the sender knows that the data has been received by the users. Users then can be charged for the service accordingly. If the sender does not receive a receipt confirmation, the transmitted data of the service is not charged to the user. It thereby must be ensured that a recipient cannot be manipulated so that it never sends receipt confirmation, as the user could then receive the service free of charge. In certain conditions, therefore, a request can be sent concerning the status of the recipient to establish why no further receipt information is reaching the sender.

In this context, it is desirable for a recipient to send a confirmation message back to the sender in the event of correct receipt and to send a non-receipt message back to the sender in the event of incorrect receipt. This non-receipt message then ensures that the data is not charged to the user. It thereby must be ensured that a recipient does not always send non-receipt messages back to the sender so that the user can receive the service free of charge. To this end, therefore, in certain conditions a request can be sent concerning the status of the recipient asking why only non-receipt messages are being sent out by the recipient.

Additional features and advantages of the present invention are described in, and will be apparent from, the following Detailed Description of the Invention and the Figures.

### BRIEF DESCRIPTION OF THE FIGURES

FIG. 1a shows a flow diagram of a correct process for the transmission of a data packet.

FIG. 1b shows a flow diagram of the incorrect transmission of a data packet.

FIG. 2 shows an exemplary embodiment of the transmission of a number of data packets in a time frame.

### DETAILED DESCRIPTION OF THE INVENTION

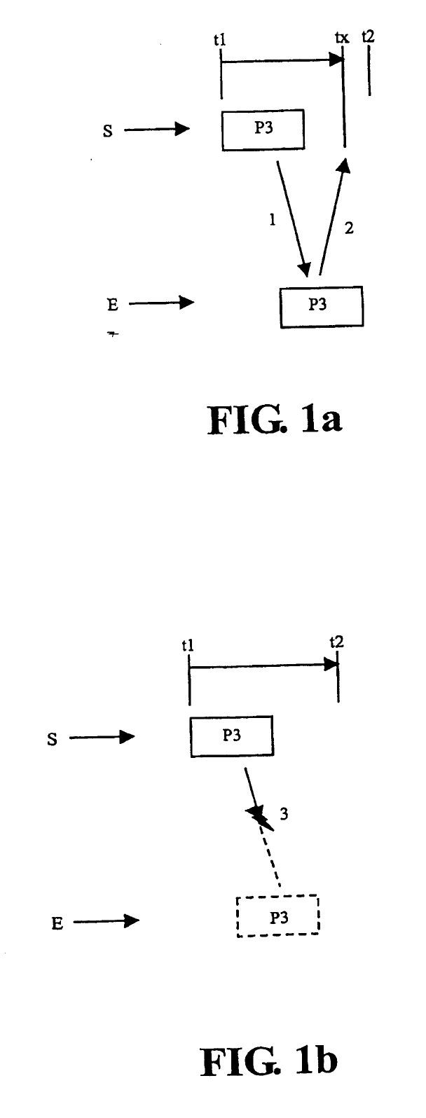

FIG. 1 shows the correct transmission of a data packet P3 from a sender S to a recipient E. When the data packet P3 is sent at time t1, a timer is started in the sender S. The receiver E receives the data packet P3 as shown by the arrow 1. On receipt, the recipient E sends a confirmation message 2 to the sender S, which reaches the sender S at time tx. Time tx is before the end of the time frame t2 started by the timer, the time frame being defined by the time t1; i.e., the time when the data packet P3 is sent.

FIG. 1b shows the incorrect transmission of a data packet P3 from a sender S to a recipient E. At time t1, the time when the data packet P3 is sent by the sender S, a timer-is again started in the sender S, the time frame of which ends at time t2. A transmission error 3 occurs during transmission. No confirmation message is therefore sent from the recipient E to the sender S.

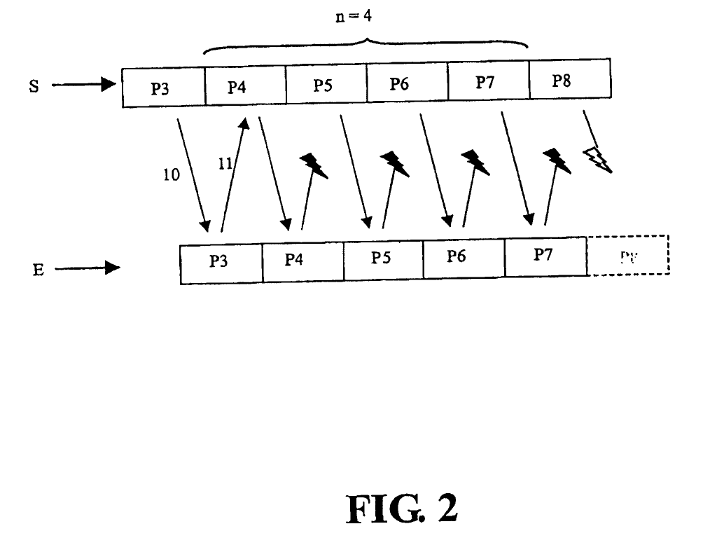

FIG. 2 shows the transmission of a series of data packets from a sender S to a recipient E. For the exemplary embodiment shown in FIG. 2, it is assumed that a message including the data packets P1 to P10 is transmitted to a group of recipients via broadcast or multicast. The data is thereby transmitted via channels (resources) common to all recipients. Dedicated or common channels are used to send the confirmation and non-confirmation information back to the network. For the sake of simplicity, in the exemplary embodiment shown in FIG. 3, only the sender S and one recipient E are considered. However, the details apply equally to each of the individual recipients of the same message.

The sender S starts to transmit the data packets 1 to 10 and sends them one after another to the recipient(s). For example, the data packet P3 is sent, as shown by the arrow 10, from the sender S to the recipient E. On receipt of the data packet 10 by the recipient E, the latter confirms receipt by sending a confirmation message 11 to the sender S.

As each individual data packet is sent, a timer (not shown) is started, with the confirmation information being expected before its expiry. If during this period, or before expiry of the time period defined by the timer, confirmation is received back from the recipient E, the timer is stopped and transmission of the data is charged for accordingly. If the recipient E does not send a confirmation message before expiry of the timer, the data is not charged to the user.

If, in the event of non-receipt, a recipient does not send confirmation back to the sender (i.e., the network, to prevent possible manipulation of a recipient so that the recipient never sends confirmation messages back to the sender), it is possible to set up a so-called send window on the network side. Such a window must be managed for each recipient in the sender. Provision of a send window ensures that data is only transmitted to a recipient until the end of the send window. According to the present invention, a request then can be sent concerning the status of the recipient, whereby it is asked why no confirmation messages are being sent.

In the exemplary embodiment shown in FIG. 2, the size of the send window is n=4. The sender S has to send the data packets P1 to P10 to the recipient E. When the data packet P3 has been sent, for example, the sender S receives a confirmation message and the send window is then “moved on” so that it starts at the data packet P4 and ends at the data packet P7. If, after sending the packet P4, the sender S receives no confirmation message, the send window is not moved on. The start of the send window remains at the data packet P4.

With a window size of n=4, the data packets P5, P6 and P7 are then transmitted, even if no confirmation messages are sent to the recipient E. After transmission of the data packet P7 and assuming that no further confirmation message has been transmitted, the end of the send window is reached.

As described above, a timer is started after the data packet P7 is sent. Once this timer has expired and when the end of the send window has been reached, a request is sent concerning the status of the recipient E. It is thereby asked why no confirmation messages have been sent. It is possible that the recipient is in a radio hole or cannot be reached for other reasons. In such a case, they should no longer be charged for the service. The send window then can be moved on again until the start of the window is at the last data packet sent.

If, however, the recipient E has been manipulated so that in principle it never sends confirmation messages, this can be determined using the request sent, whereby the user is then divested of the right to receive messages. This can be done, for example, through exclusion from the recipient group initiated by the network or, for example, by withdrawing the key for encrypting messages.

If the sender S, however, receives a confirmation message before expiry of the timer, the timer is reset, the send window is moved on (by one position) and the next data packet (P8) can be transmitted. In this case, no request is sent concerning the status of the terminal.

If confirmation messages are now duly received for all subsequent packets, the send window can be moved on until the start of the window is at the packet currently being sent.

If a recipient E only sends non-receipt messages back to the sender S, to prevent manipulation of a recipient E so that it only sends non-receipt messages back to the sender S, a counter can be set up in the sender to count the number of successive non-receipt messages. Such a counter is then managed in the sender S for each recipient.

Using such a counter ensures that data is only transmitted to a recipient E until a predefined value is reached. A request concerning the status of the recipient E then can be sent from the sender S to the recipient E, whereby it is verified why only non-receipt messages are being sent from the receiver E to the sender S.

In principle, the mode of operation is similar to the send window method described above but now the number of successive non-receipt messages is counted and a request concerning the status of the terminal E is then sent at a predefined discretionary counter reading. In such a case, it is again possible that the recipient is in a radio hole or that the data transmission is not possible for other reasons. In such a case, the recipient should no longer be charged for the service. The counter then can be reset to zero.

However, should the recipient be manipulated so that it only sends non-receipt messages, this can be determined via the request sent. The user then can be divested of the right to receive messages. This again can be done by exclusion from the recipient group initiated by the network or by withdrawing the key for encrypting the messages.

If the sender S, however, receives a confirmation message before expiry of the timer, the counter is not incremented further and the next data packet can be transmitted. No request concerning the status of the recipient E is thereby sent. If correct confirmation messages are subsequently received for all packets, the counter is reset to zero.

Although the present invention has been described with reference to specific embodiments, those of skill in the art will recognize that changes may be made thereto without departing from the spirit and scope of the present invention as set forth in the hereafter appended claims.

1-12. (canceled)

13. A method for transmitting data packets, the method comprising:
sending a data packet from a sender to a recipient;
sending a confirmation message confirming receipt of the data packet from the recipient to the sender;
starting a timer for monitoring receipt of the confirmation message when the data packet is sent;
charging for the data packet on receipt of the confirmation message;
sending a non-receipt message from the recipient to the sender if a data packet is at least one of not correctly received and not received;
storing a number of non-receipt messages received in the sender; and
sending a status request from the sender to the recipient if a limit value for non-receipt messages received is exceeded.

14. A method for transmitting data packets as claimed in claim 13, wherein no more data packets are sent if no confirmation message reaches the sender within a time frame started by the timer.

15. A method for transmitting data packets as claimed in claim 13, wherein the data packets are not charged for if no confirmation message reaches the sender within a time frame started by the timer.

16. A method for transmitting data packets as claimed in claim 13, further comprising sending a status request from the sender to the recipient if no confirmation reaches the sender within the time frame started by the timer.

17. A method for transmitting data packets as claimed in claim 13, further comprising resetting the timer on receipt of a confirmation message.

18. A terminal for transmitting data packets, comprising:
parts for sending a data packet from the terminal to a recipient;
parts for receiving from the recipient a confirmation message confirming receipt of the data packet;
a timer for monitoring receipt of the confirmation message which is started when the data packet is sent;
parts for charging for the data packet on receipt of the confirmation message;
parts for sending a non-receipt message to the recipient if a data packet is at least one of not correctly received and not received;
parts for storing a number of non-receipt messages received; and
parts for sending a status request to the recipient if a limit value for non-receipt messages received is exceeded.

19. A system for transmitting data packets, comprising:
parts for sending a data packet from a sender to a recipient;
parts for sending a confirmation message confirming receipt of the data packet from the recipient to the sender; and
a timer for monitoring receipt of a confirmation message which is started when the data packet is sent, wherein the timer is reset and the data packet is charged for on receipt of the confirmation message;
wherein if a data packet is at least one of not correctly received and not received, a non-receipt message is sent from the recipient to the sender, wherein a number of non-receipt messages received is stored in the sender, and wherein a status request is sent from the sender to the recipient if a limit value for non-receipt messages received is exceeded.

20. A system for transmitting data packets as claimed in claim 19, wherein no more data packets are sent if no confirmation message reaches the sender within a time frame started by the timer.

21. A system for transmitting data packets as claimed in claim 19, wherein the data packets are not charged for if no confirmation message reaches the sender within a time frame started by the timer.

22. A system for transmitting data packets as claimed in claim 19, wherein a status request is sent from the sender to the recipient if no confirmation message reaches the sender within a time frame started by the timer.

23. A system for transmitting data packets as claimed in claim 19, wherein the timer is reset on receipt of a confirmation message.
